(19) United States
(12) Patent Application Publication
(10) Pub. No.: US 2015/0170317 A1
(43) Pub. Date: Jun. 18, 2015

(54) Load Balancing for Consumer-Producer and Concurrent Workloads

(71) Applicants: Eric C. Samson, Folsom, CA (US); Murali Ramadoss, Folsom, CA (US)

(72) Inventors: Eric C. Samson, Folsom, CA (US); Murali Ramadoss, Folsom, CA (US)

(21) Appl. No.: 14/132,028

(22) Filed: Dec. 18, 2013

(51) Int. Cl. G06T 1/20

(52) U.S. Cl. CPC G06T 1/20

(57) ABSTRACT

In accordance with some embodiments, a system may detect whether or not a workload currently being worked on by two processors is serialized or concurrent. A workload is serialized or a producer consumer workload when the workload is such that one processor must receive the output from the other processor before it can begin. A workload is concurrent if both processors can work on the workload at the same time. In one embodiment, the nature of memory accesses can be used to determine the workload type. For example, when both processors use a shared virtual memory, the memory accesses can be tracked to detect whether serialized or concurrent workloads are involved.

### BACKGROUND

This relates generally to balancing workloads between central processing units and graphics processors.

Currently a graphics processor's workload is prepared by software running on a central processing unit. Generally, it is desirable that displayed information be rendered at a rate that is visually pleasing. For games and video content, frame rates greater than 30 frames per second are used. However faster display rates may enhance interactivity and visual quality.

Legacy implementations of frame rate control adjusts the graphics processor output frame rate by speeding up or slowing down the graphics processor rendering rate to match the target frame rate. While this controls the graphics processor energy usage directly, the impact on the central processing unit is dependent on whether the central processing unit's operating system, applications and/or drivers are responsive to the changes in back pressure from the graphics processor. It is possible that the central processing unit continues to do unnecessary work preparing frames that do not get displayed.

However, when operating on a power limited budget, which is typically the case in mobile applications, it is not always possible to arbitrarily increase the graphics processing unit frequency to obtain an acceptable frame rate. Instead the available energy budget has to be shared between the graphics processing unit and the central processing unit and potentially other non-foreground workloads. Thus the balance between the central processing unit frequency and the graphics processing unit frequency should be adjusted to maximize the user experience within the available energy budget.

### BRIEF DESCRIPTION OF THE DRAWINGS

Some embodiments are described with respect to the following figures:

FIG. 1 is a hypothetical graph of CPU and graphics frequency versus power for one embodiment;

FIG. 2 is a schematic depiction of a shared virtual memory for a central processing unit and a graphics processing unit according to one embodiment;

FIG. 3 is a plot of a CPU limited workload versus time;

FIG. 4 is a plot of various workloads versus time;

FIG. 5 is a flow chart for one embodiment;

FIG. 6 is a system depiction for one embodiment; and

FIG. 7 is a front elevational view of one embodiment.

### DETAILED DESCRIPTION

In accordance with some embodiments, a system may detect whether or not a workload currently being worked on by two processors is serialized or concurrent. A workload is serialized or a producer consumer workload when the workload is such that one processor must receive the output from the other processor before it can begin. A workload is concurrent if both processors can work on the workload at the same time. In one embodiment, the nature of memory accesses can be used to determine the workload type. For example, when both processors use a shared virtual memory, the memory accesses can be tracked to detect whether serialized or concurrent workloads are involved.

Energy efficiency can be analyzed with respect to at least three scenarios. In the first scenario, the central processing unit may be limiting the graphics workload. In a second scenario there may be a mixed workload and in a third scenario the graphics processing unit limits the graphics processing unit workload.

In the first scenario, with central processing unit limited graphics workload, the central processing unit frequency is fixed and the graphics processing unit frequency is variable. Then the central processing unit power is fixed but the graphics processing unit power consumption is variable.

In the second scenario, with a mixed workload, both the central processing unit frequency and the graphics processing unit frequency may change. Similarly, the central processing unit power consumption and the graphics processing unit power consumption both change with relatively fixed graphics processing unit performance.

In the third scenario, the graphics processing unit limits the graphics workload. The graphics performance is fixed while the central processing unit changes at a fixed graphics processing unit frequency. Likewise the central processing unit power consumption is variable while the graphics processing unit power is fixed.

Then the goal is to find an optimal operating point for both the central processing unit and the graphics processing unit within a fixed power budget. Generally overall display performance is limited by the central processing unit frame processing duration. Commonly, the central processing unit utilization is high and the system is central processing unit performance limited in this circumstance. When demand on the graphics processing unit is low, the graphics frequency may be decreased to devote more resources to the central processing unit. When central processing unit demand is high, the central processing unit frequency is generally increased.

In the graphics processing unit self-limited scenario, when demand on the central processing unit is low, the central processing unit frequency is decreased, especially when demand is high on the graphics processing unit and the graphics processing unit frequency is increasing. In such cases, where the graphics processing demand is limiting overall performance, the graphics processing unit frame time is greater than the central processing unit frame time. This is because performance is limited by the graphics frame processing duration.

In a more ideally balanced situation, both the central processing unit and the graphics processing unit have the same frame time. Performance is limited by both central processing and graphics processing unit duration and both the graphics and central processing utilizations are high.

When either central processing or graphics processing limited power, limited workloads are running, the optimum operating point for both the graphics and the central processing unit (CPU) is one that obeys the following constraints. The graphics processing unit can be decreased so that the graphics processing unit frequency is at maximum efficiency frequency. Thus power budget limits the selected operating point. The selected operating point may be the optimal CPU frequency. The optimum graphics frequency is that frequency at which the graphics processing frame time and the central processing frame time are equal. The optimum operating point for both processors is the one that corresponds to the intersection of the power versus frequency curves over a frame time window.

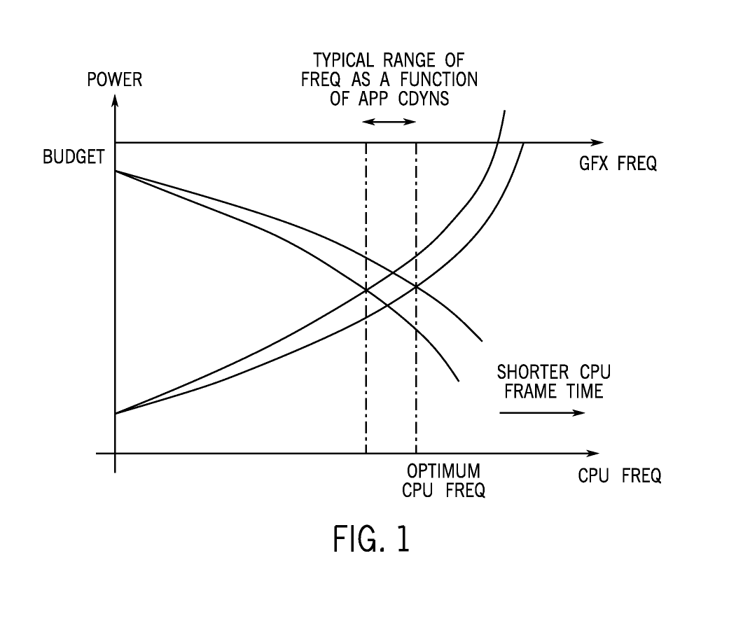

Generally, the graphics games workloads application ratios vary between 0.4 to 0.6. If the central processing unit workload application ratios vary in the same way, there is a range of frequency allocations that tend to be the most commonly optimal. Similarly, there is a range of power budget allocations that tend to be optimal most commonly. This is shown in FIG. 1 via a graph, over a range of frequencies, of power versus CPU frequency (bottom) and graphics frequency (top), showing a power budget and showing a typical range of frequency as a function of application dynamic capacitance (cdyn). Generally, a higher frequency means a shorter frame time.

Legacy implementations of power sharing control of the central and graphics processing operating units have used a combination of component utilization and some form of priority allocation to solve for the intersection of these curves. For example in one case, if the graphics engine demand is high yet the target render rate has not been achieved, then the graphics processing unit frequency is increased as high as the energy budget permits. If the graphics utilization starts dropping because the central processing unit is starving the graphics processor, the central processing unit automatically starts getting a larger share of the available budget. Similarly if the central processing unit demand is high and a graphics processing unit utilization is low, the central processing unit automatically gets a larger share of the available power budget, as the graphics processing unit is dropping its requested frequency to match its lower demand.

In some embodiments, there may be a specification of four performance fields. A minimum performance field limits the minimum performance to a programmed level over a time window. A maximum performance field limits the maximum performance to a programmed level over a time window. An aggressive performance field controls the steady state control aggressiveness. Higher performance equals faster response to utilization changes. The time window field is a window of time over which performance is controlled. Each of these fields may be specified by an interface with a given number of bits in one embodiment. Such an interface removes the bias and priority adjustments that were available in legacy applications. Thus, this interface may be adapted for graphics applications when the package is power limited.

When a package, including the central processing unit and the graphics processing unit, is power limited, both processors' frequencies may be adjusted to maintain the ratio between performance of each processor established by a driver adaptive graphics turbo and power sharing algorithm.

The driver can set the central processing unit maximum frequency limit using a conventional algorithm. When package power must be reduced, the algorithm can iterate the central processing and the graphics processing unit downwardly in steps that maintain a ratio of maximum power over requested power until it is no longer possible to do so. The minimum frequency for the central processing unit may be set to the maximum that is needed for touch response (Pn in embodiments with touch screens). The graphics driver may want to set a window of about 50 milliseconds since reasonable frame rates, in some embodiments, are between 16.666 milliseconds to 50 milliseconds in duration and may control central processing unit maximum/minimum performance.

There are two scenarios that may be addressed in accordance with some embodiments. The first is the producer-consumer scenario wherein the graphics workload is serializing between graphics and central processing unit. In such case the graphics processing unit demand is not a good indication of the required graphics frequency. For the producer-consumer workload, serialization results in a workload dependent or arbitrary amount of graphics utilization at the maximum performance point. The optimum operating point is one where taking energy budget away from either consumer results in lower performance. The optimum operating point in this case, since the workload is both central and graphics limited simultaneously, is one where the central processing unit power, when the central processing unit only is active, is the full budget power and the graphics power, when only the graphics processor is active, is the full budgeted power.

Minimize Σtᵢ=Σcᵢ/fᵢ given Power=Budget B, where t is frame duration, f is frequency, c is capacitance, gfx is graphics processor and p is power:

$$Power = \frac{{t}_{cpu} {cpu}_{power} ( {f}_{cpu} ) + {t}_{gfx} {gfx}_{power} ( {f}_{gfx} )}{{t}_{cpu} + {t}_{gfx}} = \frac{{t}_{cpu} {p}_{cpu} + {t}_{gfx} {p}_{gfx}}{{t}_{cpu} + {t}_{gfx}}$$

$$dPower = \frac{\partial Power}{\partial {p}_{cpu}} {dp}_{cpu} + \frac{\partial Power}{\partial {p}_{gfx}} {dp}_{gfx} + \frac{\partial Power}{\partial {t}_{cpu}} {dt}_{cpu} + \frac{\partial Power}{\partial {t}_{gfx}} {dt}_{gfx} = \frac{{t}_{cpu}}{{t}_{cpu} + {t}_{gfx}} {dp}_{cpu} + \frac{{t}_{gfx}}{{t}_{cpu} + {t}_{gfx}} {dp}_{gfx} + \frac{{p}_{cpu} - B}{{t}_{cpu} + {t}_{gfx}} {dp}_{cpu} + \frac{{p}_{gfx} - B}{{t}_{cpu} + {t}_{gfx}} {dp}_{gfx}$$

$$dPerf = \frac{\partial Perf}{\partial {t}_{cpu}} {dt}_{cpu} + \frac{\partial Perf}{\partial {t}_{gfx}} {dt}_{gfx} = {dt}_{cpu} + {dt}_{gfx}$$

Hence, when maximum performance is being achieved, any increase in dt_{cpu} would need to come from an equal reduction in dt_{gfx}.

$$dPower = \frac{{t}_{cpu}}{{t}_{cpu} + {t}_{gfx}} {dp}_{cpu} + \frac{{t}_{gfx}}{{t}_{cpu} + {t}_{gfx}} {dp}_{gfx} + \frac{{p}_{cpu} - {p}_{gfx}}{{t}_{cpu} + {t}_{gfx}} dt$$

Since we are also consuming full budget, dPower=0, and

$$\frac{{p}_{gfx} - {p}_{cpu}}{1} dt = \frac{{t}_{cpu}}{1} {dp}_{cpu} + \frac{{t}_{gfx}}{1} {dp}_{gfx}$$

This means that at the optimal performance point at full power budget, any increase in energy consumption of cpu needs to come at the expense of the energy consumption of gfx, so p_{gfx}=p_{cpu}=p. Back substituting this in the original power equation:

$$Power = \frac{{t}_{cpu} p + {t}_{gfx} p}{{t}_{cpu} + {t}_{gfx}} = p + B$$

A conceptual example of a load balancing algorithm that works reasonably well for serializing workloads is to treat these workloads as if the cores exhibited high demand as measured during the time they are the only cores active.

The power sharing algorithm for a serializing workload ideally switches energy margin allocation instantaneously between the central processing unit and the graphics processor in a way that both processors use an average power substantially equal to budgeted power B, when they are working. Whereas the power sharing algorithm for non-serializing limited workloads needs to allocate energy margin such that the correct ratio of central processing to graphics processing unit power is maintained for that workload over the frame interval. Unfortunately, serializing workloads do not currently advertise themselves as such. Moreover it is necessary to know that a workload is a serialized workload in order to find its optimum power limited operating point.

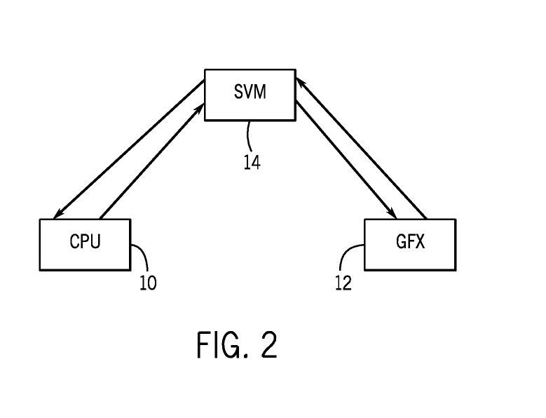

Thus, referring to FIG. 2, a central processing unit 10 and a graphics processing unit 12 may be provided physically independently or in the same package. The central processing and the graphics processing unit may have their processes associated in a way so that information is available about the needs of each unit. In one embodiment this may be implemented by a shared virtual memory 14 which is a memory addressed by both the central and graphics processing unit. In another embodiment a software, firmware or hardware unit may snoop memory accesses.

Both processors may share the same page table and process address space identifiers. Then it is possible to expose the central processing and graphics unit application context specific metrics to the platform and the graphics processing unit power management controller. These metrics may include the per application context duty cycle on both the central and graphics processors, the per application context concurrency of the engines, and the per application context non-concurrency of the engines as well as the per application track energy consumptions of the engines. One way these metrics can be collected is by monitoring memory accesses to determine whether or not the same memory locations are being accessed by both processors. If the same memory addresses are being accessed, a more concurrent oriented workload is indicated and if this is not the case, a more producer/consumer oriented workload is indicated.

These metrics can then be used to identify whether the workload is serialized in that the workloads have near zero concurrency for the same context. A concurrent workload shows that the CPU is working on non-graphics contexts. If concurrency is identified, it is then possible to reduce the energy budget available to one context to allow more energy for the other context. Another solution is to schedule one context less often or for shorter durations.

When the central processing unit workload is concurrent with the graphics processing unit workload, the central processing unit demand for the concurrent workload has no applicability to the graphics workload and can result in a graphics related workload CPU task not getting sufficient allocation on the central processing unit to keep the graphics processor running properly. Once the workload's type is identified, then it is possible to optimize the performance for the workloads type. If it is assumed that the workload input/output bounded, then operations can be scaled with frequency including the graphics processor frequency. The voltage versus frequency ideal operating point may be found.

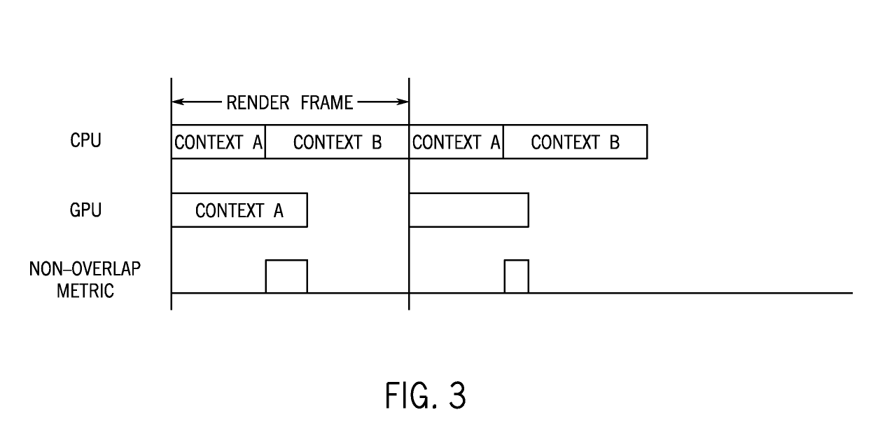

Thus, referring to FIG. 3, there is a depiction of a central processing unit limited concurrent workload. From the viewpoint of the graphics processing context A, the central processing context A fully utilizes the central processing unit and there is a 20-30% non-overlap metric.

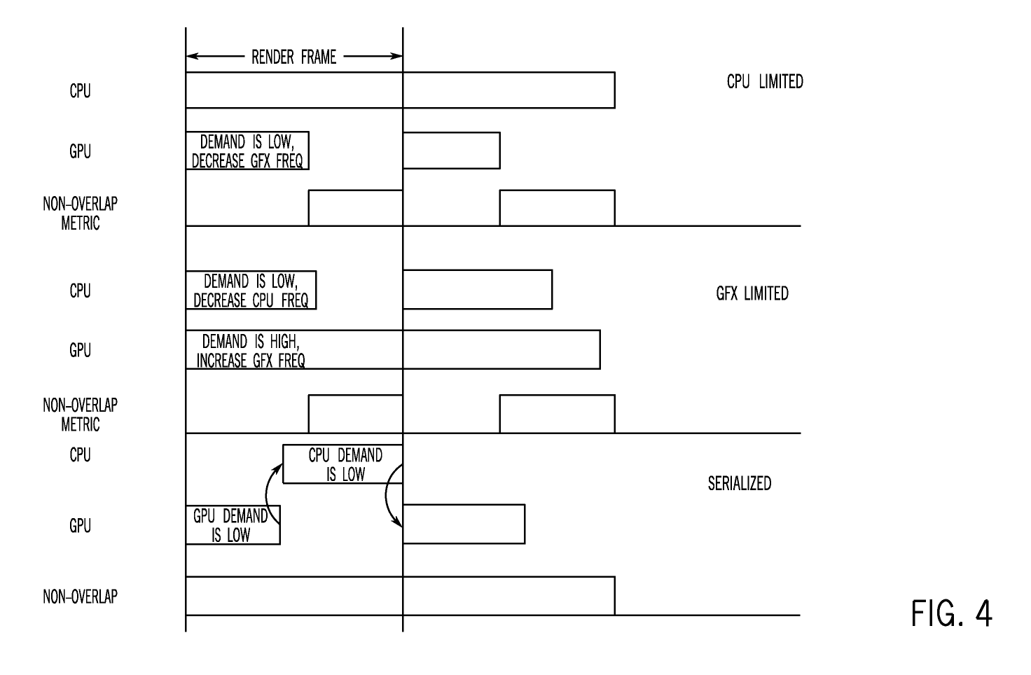

At the top of FIG. 4, there is an example of a central processing unit limited workload with 40% non-overlap metric. In the graphics processing unit, demand is low, so the graphics processing unit frequency can be decreased because the frequency is too high. In the next example where the graphics processing unit limits performance with 40% non-overlap metric, then demand in the central processing unit is low and so its frequency can be reduced while the graphics processing unit demand is high and so its frequency may be increased. In the case of a serialized, non-overlapping workload shown in the third depiction, if the graphics processing demand is low and the central processing unit demand is low, so all the budget is diverted to the unit that is actually in operation at the time.

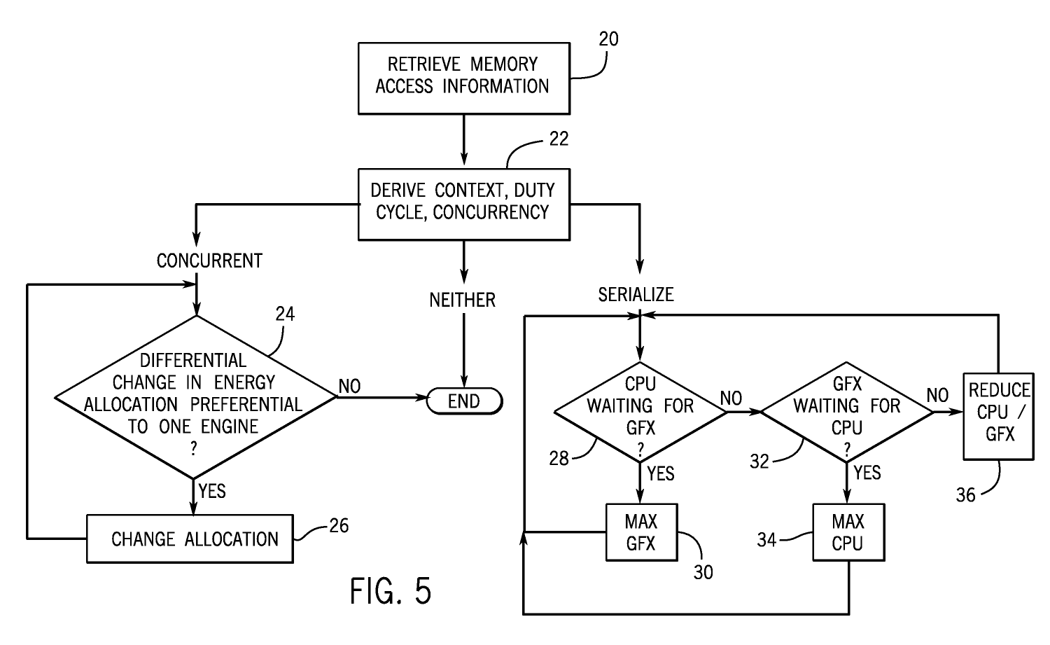

Referring to FIG. 5, a sequence for detecting and handling both serialized and concurrent workloads according to one embodiment may be implemented in software, firmware and/or hardware. In software and firmware embodiments it may be implemented by computer executed instructions stored in one or more non-transitory computer readable media including a magnetic, optical or semiconductor storage. In one embodiment the sequence may be associated with either the central or graphics processing unit and may be included therein or may be run from a separate controller as another example.

Initially, the memory access information is retrieved as indicated in block 20. This information may be analyzed to determine whether the workload is one of serialized or concurrent. Specifically, the algorithm derives the context, duty cycle, and concurrency as indicated in block 22. If the workload is determined to be concurrent then a determination is made as to whether the differential change in energy allocation is preferable to either the graphics or the central processing unit as indicated in block 24. If not, the flow ends. If so, the allocation of energy between the two processors is changed, as indicated in block 26.

In contrast, a serialized workload is indicated, then at diamond 28 a check determines whether the central processing unit is waiting for the graphics processing unit. If so, the graphics processor is given the maximum energy allocation. This generally means it gets the best combination of frequency and voltage.

Conversely if the check at diamond 28 indicates that it is not the central processing unit waiting for the graphics processing unit in a serialized case, then a check at diamond 32 determines whether the graphics processing unit is waiting for the central processing unit. If so, the budget of the central processing unit is maximized which generally means that it would get the best ratio of frequency and voltage. However, if the check at diamond 32 indicates that the graphics processing unit is no longer waiting for the central processing unit, then the operating conditions of both the central processing and/or graphics processing unit may be reduced, as indicated in block 36, to reduce power consumption.

If the CPU is waiting for the graphics processor then the maximum energy allocation may be applied to the graphics processor as indicated at block 30. This may include affording it the maximum frequency and/or voltage and allocating the energy consumption entirely or almost entirely to the graphics processor. Conversely if the graphics processor is waiting for the CPU as determined in diamond 32 then the maximum energy allocation may be applied to the CPU as indicated in block 34.

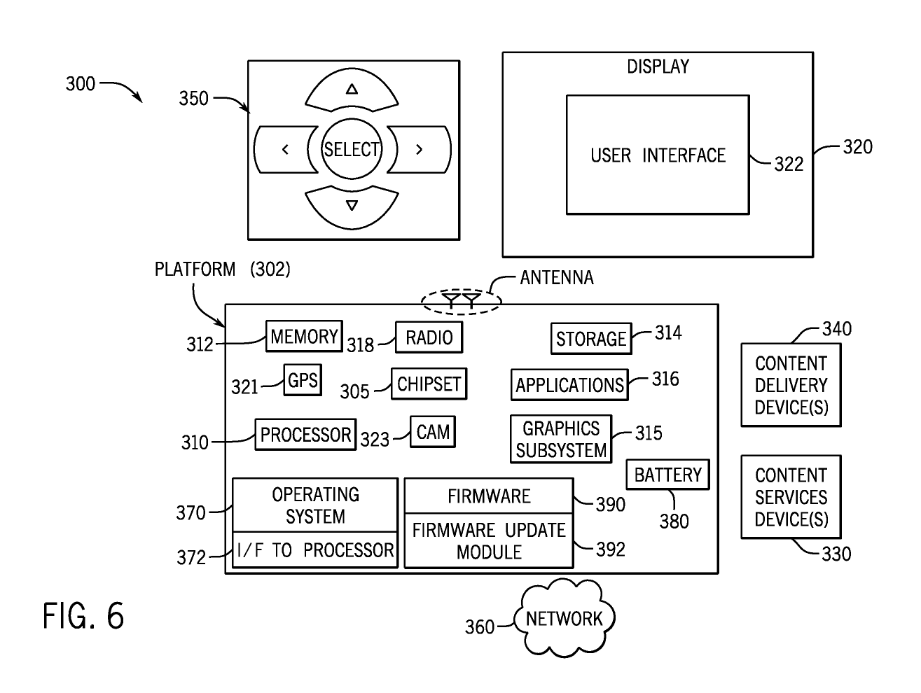

FIG. 6 illustrates an embodiment of a system 300. In embodiments, system 300 may be a media system although system 300 is not limited to this context. For example, system 300 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 300 comprises a platform 302 coupled to a display 320. Platform 302 may receive content from a content device such as content services device(s) 330 or content delivery device(s) 340 or other similar content sources. A navigation controller 350 comprising one or more navigation features may be used to interact with, for example, platform 302 and/or display 320. Each of these components is described in more detail below.

In embodiments, platform 302 may comprise any combination of a chipset 305, processor 310, memory 312, storage 314, graphics subsystem 315, applications 316 and/or radio 318. Chipset 305 may provide intercommunication among processor 310, memory 312, storage 314, graphics subsystem 315, applications 316 and/or radio 318. For example, chipset 305 may include a storage adapter (not depicted) capable of providing intercommunication with storage 314.

Processor 310 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 310 may comprise dual-core processor(s), dual-core mobile processor(s), and so forth. The processor may implement the sequence of FIG. 5 together with memory 312.

Memory 312 may be implemented as a volatile memory device such as, but not limited to, a Random Access Memory (RAM), Dynamic Random Access Memory (DRAM), or Static RAM (SRAM).

Storage 314 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 314 may comprise technology to increase the storage performance enhanced protection for valuable digital media when multiple hard drives are included, for example.

Graphics subsystem 315 may perform processing of images such as still or video for display. Graphics subsystem 315 may be a graphics processing unit (GPU) or a visual processing unit (VPU), for example. An analog or digital interface may be used to communicatively couple graphics subsystem 315 and display 320. For example, the interface may be any of a High-Definition Multimedia Interface, DisplayPort, wireless HDMI, and/or wireless HD compliant techniques. Graphics subsystem 315 could be integrated into processor 310 or chipset 305. Graphics subsystem 315 could be a stand-alone card communicatively coupled to chipset 305.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 318 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 318 may operate in accordance with one or more applicable standards in any version.

In embodiments, display 320 may comprise any television type monitor or display. Display 320 may comprise, for example, a computer display screen, touch screen display, video monitor, television-like device, and/or a television. Display 320 may be digital and/or analog. In embodiments, display 320 may be a holographic display. Also, display 320 may be a transparent surface that may receive a visual projection. Such projections may convey various forms of information, images, and/or objects. For example, such projections may be a visual overlay for a mobile augmented reality (MAR) application. Under the control of one or more software applications 316, platform 302 may display user interface 322 on display 320.

In embodiments, content services device(s) 330 may be hosted by any national, international and/or independent service and thus accessible to platform 302 via the Internet, for example. Content services device(s) 330 may be coupled to platform 302 and/or to display 320. Platform 302 and/or content services device(s) 330 may be coupled to a network 360 to communicate (e.g., send and/or receive) media information to and from network 360. Content delivery device(s) 340 also may be coupled to platform 302 and/or to display 320.

In embodiments, content services device(s) 330 may comprise a cable television box, personal computer, network, telephone, Internet enabled devices or appliance capable of delivering digital information and/or content, and any other similar device capable of unidirectionally or bidirectionally communicating content between content providers and platform 302 and/display 320, via network 360 or directly. It will be appreciated that the content may be communicated unidirectionally and/or bidirectionally to and from any one of the components in system 300 and a content provider via network 360. Examples of content may include any media information including, for example, video, music, medical and gaming information, and so forth.

Content services device(s) 330 receives content such as cable television programming including media information, digital information, and/or other content. Examples of content providers may include any cable or satellite television or radio or Internet content providers.

In embodiments, platform 302 may receive control signals from navigation controller 350 having one or more navigation features. The navigation features of controller 350 may be used to interact with user interface 322, for example. In embodiments, navigation controller 350 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures, facial expressions or sounds.

Movements of the navigation features of controller 350 may be echoed on a display (e.g., display 320) by movements of a pointer, cursor, focus ring, or other visual indicators displayed on the display. For example, under the control of software applications 316, the navigation features located on navigation controller 350 may be mapped to virtual navigation features displayed on user interface 322, for example. In embodiments, controller 350 may not be a separate component but integrated into platform 302 and/or display 320. Embodiments, however, are not limited to the elements or in the context shown or described herein.

In embodiments, drivers (not shown) may comprise technology to enable users to instantly turn on and off platform 302 like a television with the touch of a button after initial boot-up, when enabled, for example. Program logic may allow platform 302 to stream content to media adaptors or other content services device(s) 330 or content delivery device(s) 340 when the platform is turned “off.” In addition, chip set 305 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 300 may be integrated. For example, platform 302 and content services device(s) 330 may be integrated, or platform 302 and content delivery device(s) 340 may be integrated, or platform 302, content services device(s) 330, and content delivery device(s) 340 may be integrated, for example. In various embodiments, platform 302 and display 320 may be an integrated unit. Display 320 and content service device(s) 330 may be integrated, or display 320 and content delivery device(s) 340 may be integrated, for example.

In various embodiments, system 300 may be implemented as a wireless system, a wired system, or a combination of both. When implemented as a wireless system, system 300 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 300 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 302 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 6.

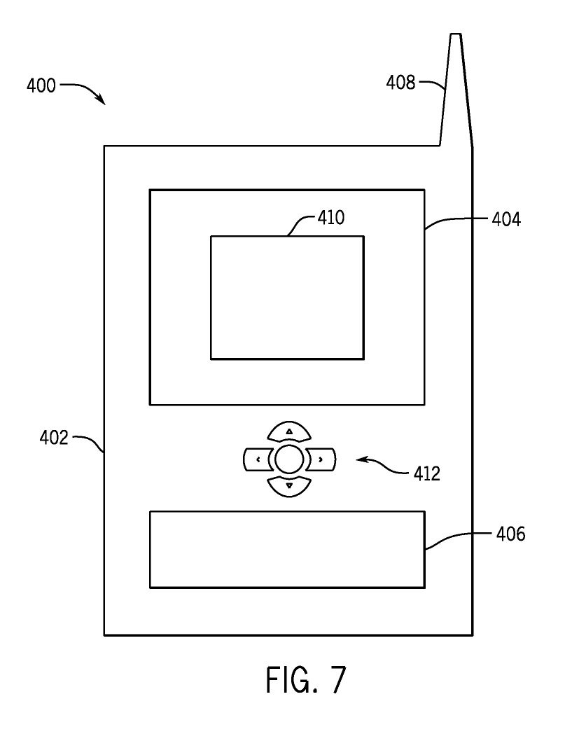

As described above, system 300 may be embodied in varying physical styles or form factors. FIG. 7 illustrates embodiments of a small form factor device 400 in which system 300 may be embodied. In embodiments, for example, device 400 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

The processor 310 may communicate with a camera 322 and a global positioning system sensor 320, in some embodiments. A memory 312, coupled to the processor 310, may store computer readable instructions for implementing the sequence shown in FIG. 5 in software and/or firmware embodiments.

As shown in FIG. 7, device 400 may comprise a housing 402, a display 404, an input/output (I/O) device 406, and an antenna 408. Device 400 also may comprise navigation features 412. Display 404 may comprise any suitable display unit for displaying information appropriate for a mobile computing device. I/O device 406 may comprise any suitable I/O device for entering information into a mobile computing device. Examples for I/O device 406 may include an alphanumeric keyboard, a numeric keypad, a touch pad, input keys, buttons, switches, rocker switches, microphones, speakers, voice recognition device and software, and so forth. Information also may be entered into device 400 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

The following clauses and/or examples pertain to further embodiments:

One example embodiment may be a method comprising detecting whether a workload handled by two processors is serialized or concurrent, if said workload is serialized, determine which of the two processors is waiting for the other processor, and diverting resources from said waiting processor to the other processor. The method may also include monitoring memory accesses to detect whether the workload is serialized or concurrent. The method may also include using a stored virtual memory for both processors. The method may also include wherein if said workload is concurrent, determining whether a differential change in energy allocation between the processors is preferential to one processor. The method may also include allocating energy margin to maintain a ratio of central processing to graphics processing power over a frame interval. The method may also include causing both processors' average power to substantially equal budgeted power. The method may also include determining at least one of per application context duty cycle for both processors, per application concurrency for both processors or per application non-concurrency for both processors. The method may also include reducing an energy budget for one context and allocating more budget for another context. The method may also include determining an amount of overlap between two contexts. The method may also include wherein if the workload is serialized, diverting all of the processor's power budget to an active processor.

In another example embodiment, one or more non-transitory computer readable media storing instructions executed by a processor to perform a method comprising detecting whether a workload handled by two processors is serialized or concurrent, if said workload is serialized, determine which of the two processors is waiting for the other processor, and diverting resources from said waiting processor to the other processor. The media may further store instructions to perform said method including monitoring memory accesses to detect whether the workload is serialized or concurrent. The media may further store instructions to perform said method including using a stored virtual memory for both processors. The media may further store instructions to perform said method wherein if said workload is concurrent, said method including determining whether a differential change in energy allocation between the processors is preferential to one processor. The media may further store instructions to perform said method including allocating energy margin to maintain a ratio of central processing to graphics processing power over a frame interval. The media may further store instructions to perform said method including said method including causing both processors' average power to substantially equal budgeted power. The media may further store instructions to perform said method including determining at least one of per application context duty cycle for both processors, per application concurrency for both processors or per application non-concurrency for both processors. The media may further store instructions to perform said method including reducing an energy budget for one context and allocating more budget for another context. The media may further store instructions to perform said method including determining an amount of overlap between two contexts. The media may further store instructions to perform said method wherein if the workload is serialized, diverting all of the processor's power budget to an active processor.

Another example embodiment may be an apparatus comprising a processing device to detect whether a workload handled by two processors is serialized or concurrent, if said workload is serialized, determine which of the two processors is waiting for the other processor, and divert resources from said waiting processor to the other processor, and a storage coupled to said device. The apparatus may include said device to monitor memory accesses to detect whether the workload is serialized or concurrent. The apparatus may include said device to use a stored virtual memory for both processors. The apparatus may include said device wherein if said workload is concurrent, said device to determine whether a differential change in energy allocation between the processors is preferential to one processor. The apparatus may include said device to allocate energy margin to maintain a ratio of central processing to graphics processing power over a frame interval. The apparatus may include said device to cause both processors' average power to substantially equal budgeted power. The apparatus may include said device to determine at least one of per application context duty cycle for both processors, per application concurrency for both processors or per application non-concurrency for both processors. The apparatus may include a display communicatively coupled to the device. The apparatus may include a battery coupled to the device. The apparatus may include firmware and a module to update said firmware.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present disclosure. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While a limited number of embodiments have been described, those skilled in the art will appreciate numerous modifications and variations therefrom. It is intended that the appended claims cover all such modifications and variations as fall within the true spirit and scope of this disclosure.

What is claimed is:

1. A method comprising:
detecting whether a workload handled by two processors is serialized or concurrent;
if said workload is serialized, determine which of the two processors is waiting for the other processor; and
diverting resources from said waiting processor to the other processor.

2. The method of claim 1 including monitoring memory accesses to detect whether the workload is serialized or concurrent.

3. The method of claim 2 including using a stored virtual memory for both processors.

4. The method of claim 1 wherein if said workload is concurrent, determining whether a differential change in energy allocation between the processors is preferential to one processor.

5. The method of claim 4 including allocating energy margin to maintain a ratio of central processing to graphics processing power over a frame interval.

6. The method of claim 1 including causing both processors' average power to substantially equal budgeted power.

7. The method of claim 1 including determining at least one of per application context duty cycle for both processors, per application concurrency for both processors or per application non-concurrency for both processors.

8. The method of claim 4 including reducing an energy budget for one context and allocating more budget for another context.

9. The method of claim 4 including determining an amount of overlap between two contexts.

10. The method of claim 1 wherein if the workload is serialized, diverting all of the processor's power budget to an active processor.

11. One or more non-transitory computer readable media storing instructions executed by a processor to perform a method comprising:
detecting whether a workload handled by two processors is serialized or concurrent;
if said workload is serialized, determine which of the two processors is waiting for the other processor; and
diverting resources from said waiting processor to the other processor.

12. The media of claim 11, said method including monitoring memory accesses to detect whether the workload is serialized or concurrent.

13. The media of claim 12, said method including using a stored virtual memory for both processors.

14. The media of claim 11 wherein if said workload is concurrent, said method including determining whether a differential change in energy allocation between the processors is preferential to one processor.

15. The media of claim 14, said method including allocating energy margin to maintain a ratio of central processing to graphics processing power over a frame interval.

16. The media of claim 11, said method including causing both processors' average power to substantially equal budgeted power.

17. The media of claim 11, said method including determining at least one of per application context duty cycle for both processors, per application concurrency for both processors or per application non-concurrency for both processors.

18. The media of claim 14, said method including reducing an energy budget for one context and allocating more budget for another context.

19. The media of claim 14, said method including determining an amount of overlap between two contexts.

20. The media of claim 11, said method wherein if the workload is serialized, diverting all of the processor's power budget to an active processor.

21. An apparatus comprising:
a processing device to detect whether a workload handled by two processors is serialized or concurrent, if said workload is serialized, determine which of the two processors is waiting for the other processor, and divert resources from said waiting processor to the other processor; and
a storage coupled to said device.

22. The apparatus of claim 21, said device to monitor memory accesses to detect whether the workload is serialized or concurrent.

23. The apparatus of claim 22, said device to use a stored virtual memory for both processors.

24. The apparatus of claim 21 wherein if said workload is concurrent, said device to determine whether a differential change in energy allocation between the processors is preferential to one processor.

25. The apparatus of claim 24, said device to allocate energy margin to maintain a ratio of central processing to graphics processing power over a frame interval.

26. The apparatus of claim 21, said device to cause both processors' average power to substantially equal budgeted power.

27. The apparatus of claim 21, said device to determine at least one of per application context duty cycle for both processors, per application concurrency for both processors or per application non-concurrency for both processors.

28. The apparatus of claim 21 including a display communicatively coupled to the device.

29. The apparatus of claim 21 including a battery coupled to the device.

30. The apparatus of claim 21 including firmware and a module to update said firmware.
